(19) United States
(12) Patent Application Publication
(10) Pub. No.: US 2009/0290698 A1
(43) Pub. Date: Nov. 26, 2009

(54) METHOD AND DEVICE FOR TRANSMITTING VOICE DATA IN A COMMUNICATION NETWORK

(75) Inventors: Jonas LUNDGREN, Bromma (SE); Mikael SALMEN, Arsta (SE); Christian EHRENBORG, Saltsjo-Duvnas (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/126,156

(22) Filed: May 23, 2008

(51) Int. Cl. H04M 1/56; G10L 11/00

(52) U.S. Cl. 379/142.04; 704/201; 704/E17.003

(57) ABSTRACT

A method of transmitting voice data in a communication network and a device for transmitting such voice data, as well as a method of receiving voice data in a communication network and a device for receiving such data are provided. The voice data is comprised in a data packet transmitted by the transmitting device to the receiving device.

### FIELD OF THE INVENTION

The present invention relates generally to a method of transmitting voice data in a communication network and a method of receiving voice data in a communication network. Further, the invention relates to a device for receiving voice data in a communication network, and to a device for transmitting voice data in a communication network. In particular, the invention relates to communication devices, such as telephones, cellular phones, walkie-talkies, computers and the like.

### BACKGROUND OF THE INVENTION

At present, a range of techniques exists which enable the communication of two or more persons over a communication network. Examples of communication devices used with these techniques include cellular phones, fixed-line phones, voice over IP telephones which may be implemented on a personal computer, walkie-talkies and other communication devices. It is also possible to establish connections between different kinds of devices, such as initiating a call from a soft phone to a cellular phone. When two persons are communicating over a communication network, they generally desire to know the identity of the person they are communicating with. At present, a system is available called caller line identification presentation (CLIP), which is for example implemented in integrated services digital network (ISDN) communication devices. Such a device is capable of displaying the telephone number of a telephone from which the device is called on a display. The identification number or telephone number is transmitted on a separate signaling channel using a session control protocol (for example SS7). Using this method, only the identification number is transmitted, and no further information on the person initiating the call or the person receiving the call is available to the other person.

Similarly, in cellular phones the CLI of a caller may be transmitted using a call setup request (for example in GSM/3G networks). By simply displaying the CLI of the caller, it is generally not possible for the user of the called device to identify the person calling.

A further frequently used application of communication networks is the possibility of holding a telephone conference. As a plurality of persons may participate in a telephone conference, it is particularly useful for a participant to know the identities of the other participants. In particular, it is desirable to known the identity of the person presently speaking. This is particularly true as it is often very difficult for a participant to identify the other persons simply by recognizing their voice. A conventional method for identifying a person currently speaking in a telephone conference uses voice recognition, wherein it compares a voice sample of the person with the current speech. Yet such a method requires a rather complex and computationally expensive system, and further requires the participants to provide voice samples.

A similar problem arises in ad-hoc voice sessions, wherein a plurality of persons may communicate over a single communication channel, and accordingly, it is difficult for a participant of the session to identify a person presently speaking. In particular, when a new participant enters such a session, he can not be easily identified. At present, no easy to implement methods exist for identifying a current speaker when using one of the above-mentioned communication devices. Accordingly, a need exists for providing a possibility of identifying a speaker or subscriber when communicating over a communication network. In particular, there is the need for an easy to implement and cost effective method for enabling speaker identification. It is further desirable to provide the appropriate equipment for implementing such a method.

### SUMMARY OF THE INVENTION

The present invention provides a method, a device and a processor readable medium for transmitting voice data in a communication network.

According to a first aspect of the invention, a method of transmitting voice data in a communication network comprises retrieving identification information identifying a subscriber of a transmitting device. A data packet comprising voice data and said identification information is created. By means of said transmitting device, the data packet is transmitted to a receiving device. The data packet is such that by receiving the data packet, the receiving device is enabled to provide the identification information to a user of the receiving device. As voice data and identification information are transmitted within a data packet, both voice data and identification information are available to the receiving device.

According to an embodiment of the invention, the identification information may comprise a name, an e-mail address, a cellular phone number, a fixed-line phone number, a mobile subscriber integrated services digital network number (MSISDN), a caller line identification (CLI), a voice over internet protocol (VIP) user identification or the like, or any combination thereof. There are several possibilities of including the identification information in a data packet. Examples are attaching the identification information in the form of an identification frame to the end of the data packet or to comprise the identification information in a data section of a voice frame comprising the voice data. The identification information comprised in the data packet may for example have a length of between 8 and 64 bytes. It may also have a length of between 16 and 32 bytes.

It should be understood that the data packet may be a media packet in general and may as such comprise data others than voice data. It may for example be a video data packet comprising video data, which may include said voice data. In other embodiments, the packet may mainly comprise voice data.

According to a further embodiment, the data packet is a real-time transport protocol (RTP) data packet. Such a data packet may be transmitted by using a transport protocol such as the user datagram protocol (UDP). As an example, the voice data may be comprised in a data packet in the form of at least one voice frame. Such a voice frame may be encoded by using an adaptive multirate (AMR) or adaptive multirate wideband (AMR-WB) format. Yet other formats may also be used, such as pulse code modulation (PCM). The method is generally applicable to all kinds of codecs, including lossless audio codecs, such as PCM, A-law/mu-law (G.711), compressed PCM formats and the like, and lossy audio codecs, such as AMR, iLBC, MP3, AAC, and the like. Identification information may replace for example some audio information (e.g. in the high frequency spectrum), and audio quality may be comprised for identification information.

According to a further embodiment of the invention, a plurality of data packets may be transmitted by the transmitting device. The identification information may then be comprised in each of said data packets. Accordingly, the identification information is always available to the receiving device when receiving data packets comprising voice data. A data packet may for example be part of a media stream transmitted over a connection established for communications between at least the transmitting device and the receiving device. A connection may also be established for communications between more than these two devices. Examples of such a connection include a telephone connection, a telephone conference, a video conference, an ad-hoc voice session, voice over internet protocol (VoIP) telephony, or a two-way radio connection or the like. Communication devices connected over such a connection may both receive and transmit media streams comprising data packets. According to another embodiment, the method may further comprise the following steps at the receiving device: receiving the data packet, accessing the identification information comprised in said data packet and providing the identification information to a user of the receiving device. It is thus possible to inform the user of the receiving device of the identity of the subscriber as soon as the data packet with the voice data is received.

According to another aspect of the invention, a method of receiving voice data in a communication network comprises a step of receiving a data packet comprising voice data and identification information by a receiving device. The identification information comprised in the data packet is then accessed. The identification information is provided to a user of the receiving device, wherein the identification information identifies a subscriber of a transmitting device transmitting said data packet.

According to an embodiment, the identification information is displayed to the user of the receiving device. The identification information may be displayed while voice samples using said voice data is given out to the user in audible form. While giving out the voice, the receiving device may for example show who is speaking. As the voice data and the identification information are received in the same data packet, the identification information is generally available in the receiving device when voice is given out, even in a case where no prior exchange of information has occurred.

In another embodiment where text is transcribed from received voice data, the identification information may be displayed while the text is given out to the user, e.g. in readable form.

According to another embodiment of the invention, the method further comprises the steps of receiving a plurality of data packets comprising voice data and identification information as part of a media stream exchanged between the transmitting device and the receiving device, assembling the received voice data to a voice signal and giving out the voice signal over a loudspeaker. Not every data packet has to comprise both voice data and identification information. The transmitting device and the receiving device may both transmit and receive media streams. Data packets comprising voice data and identification information may also be received from plural transmitting devices. The identification information may then be provided to the user while the voice data received with the identification information is given out to the user. Even when communicating with plural persons, the user is provided with the information who is currently speaking.

According to another embodiment, the voice data and the identification information may be stored at the receiving device. Thus, a conversation log may be created, in which it is possible to identify the person from whom a communication originates.

According to yet another embodiment of the invention, the data packet is directly received from a transmitting device transmitting said data packet during an ad-hoc voice session. An ad-hoc voice session may comprise plural transmitting devices, and the identification of the users of these devices may thus be enabled. By receiving the identification information, the receiving device may further be enabled to initiate the establishment of a new connection with the transmitting device. Just as an example, the user of the receiving device may be enabled to establish a private connection to a transmitting device, the identification information of the subscriber of which was displayed on the receiving device.

According to another aspect of the invention, a device for transmitting voice data in a communication network is provided, the device comprising a memory in which identification information identifying a subscriber of said device is stored and a processing unit for creating a data packet comprising voice data and identification information. The device further comprises a transmitting unit for transmitting said data packet to a receiving device. The data packet is such that by receiving said data packet, the receiving device is enabled to provide the identification information to a user of the receiving device.

According to an embodiment, the device further comprises a microphone for recording a voice signal. The processing unit may generate the voice data from at least a part of said voice signal. The processing unit may for example be designed so as to create the data packets in a real-time transport protocol format. The data packet may comprise at least one adaptive multirate (AMR) or adaptive multirate wideband (AMR-WB) encoded voice frame and said identification information. A data packet may also comprise plural voice frames, and the identification information may be part of one or of plural of these voice frames, or included in another part of the packet. Other embodiments may use other types of transport protocols and other types of encoding.

According to an embodiment, the device may be implemented as a cellular phone, a fixed-line phone, an internet protocol (IP) telephone, a soft phone, a teleconference system, a video teleconference (VTC) system, a video telephone or a telecommunication system.

According to a further aspect of the invention, a device for receiving voice data in a communication network is provided. The device comprises a receiving unit receiving a data packet, said data packet comprising voice data and identification information. The identification information identifies a subscriber of a transmitting device transmitting said data packets. The device further comprises a processing unit accessing the identification information comprised in said received data packet and an output unit for providing the identification information to a user of said device. By receiving the data packet with the voice data, the device is thus enabled to provide a user with the identification information.

According to an embodiment, the processing unit is designed so as to compose a voice signal of said voice data. The device may further comprise a voice output unit for giving out the voice signal. The voice signal is given out while the identification information received with the voice data is provided to the user. The voice output unit may have the form of a loudspeaker, earphones, a headset or the like.

According to another embodiment, the receiving unit is designed so as to receive data packets from plural transmitting devices. The identification information received from a transmitting device may then be provided to the user while the voice data received from the same transmitting device is given out to the user. If for example used in a telephone conference, wherein voice data is received from plural participating devices, the device may then display the identification information of the person presently speaking.

According to a further embodiment, the device may further comprise a memory for storing the voice data and the identification information. The device is thus enabled to generate a conversation log.

According to another embodiment, the device for receiving voice data in a communication network may be implemented in the form of a cellular phone, a fixed-line phone, an internet protocol (IP) telephone, a soft phone, a teleconference system, a video teleconference (VTC) system, a video telephone, or a telecommunication system.

According to a further aspect of the invention, a device for transmitting voice data in a communication network and a device for receiving voice data in a communication network may be implemented within one device.

In accordance with another embodiment of the invention, a processor readable medium having computer-executive instructions for receiving or transmitting voice data in a communication network is provided. The computer-executable instructions, when executed by a processor unit of a corresponding device, may perform any of the above-described methods.

Features of the above embodiments and aspects of the invention may be combined to form new embodiments.

The foregoing and other features and advantages of the invention will become further apparent from the following detailed description of illustrative embodiments when read in conjunction with the drawings.

### BRIEF DESCRIPTION OF THE DRAWINGS

Embodiments of the present invention are illustrated by the accompanying figures, wherein:

FIG. 1 is schematic drawing of a communication device according to an embodiment of the invention;

FIG. 2 is a flow diagram of an embodiment of the method of the present invention;

FIG. 3 is a flow diagram of another embodiment of a method according to the invention;

FIGS. 4A-E are schematic diagrams of different embodiments of communication networks, which comprise embodiments of devices for receiving and transmitting voice data in the communication networks;

FIGS. 5A and 5B are schematic representations of embodiments of data packets which comprise identification information;

FIG. 6 is a flow diagram of another embodiment of a method according to the invention.

In the figures, like reference symbols indicate like elements.

### DETAILED DESCRIPTION OF THE INVENTION

The term data packet as used in the disclosure is to be understood in its most general meaning. It may for example be a block of data, possibly comprising a header and/or trailer, yet it may also be a sub-unit of a data stream, such as a data frame. A data frame may also comprise a header and/or trailer. A packet may also be a data frame. A packet may for example be an asynchronous transfer mode (ATM) cell, an IP packet, a datagram of a user datagram protocol (UDP) service, a voice frame of an adaptive multirate (AMR) encoded voice signal, a real-time transport protocol (RTP) packet and the like. It may also be a data frame of a digital telecommunications system, a frame of a time division multiplexing (TDM) system or a frame in a pulse code modulation (PCM) system.

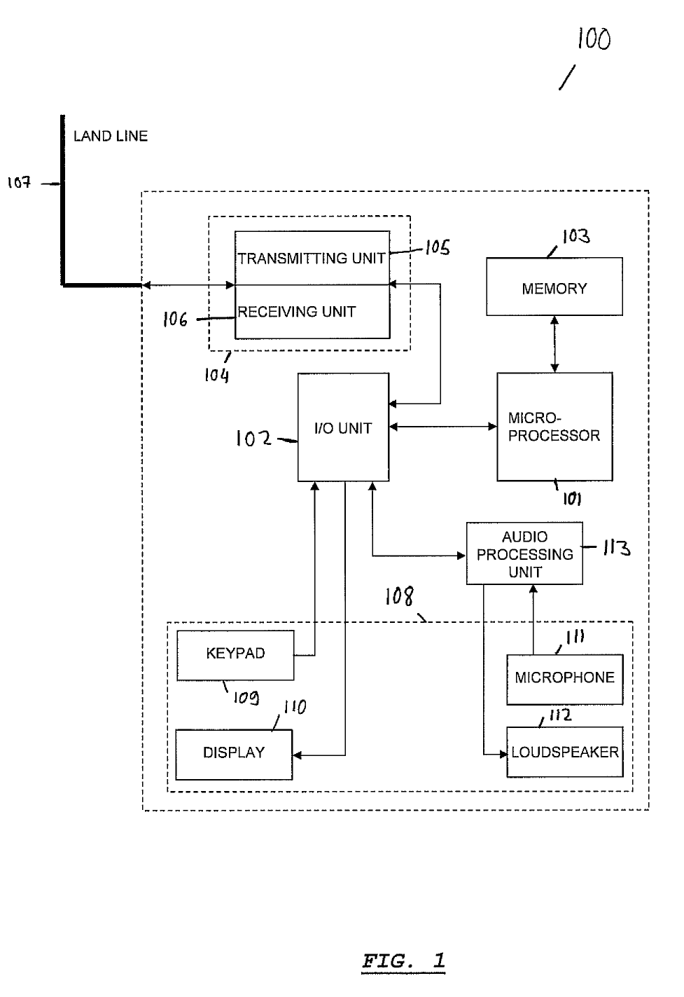

The embodiment of FIG. 1 shows a communication device 100 capable of transmitting and receiving voice data in a communication network. In the following, the general operation of the exemplary device 100 will be described, as well as possible implementations of the device.

The communication device 100 comprises a processing unit in the form of a microprocessor 101 interfacing several components of the communication device by means of input/output unit 102. The exchange of control signals or data between the components may be achieved by a bus system (not shown). The microprocessor 101 can control the operation of the device 100 according to programs stored in memory 103. Microprocessor 101 may be implemented as a single microprocessor or as multiple microprocessors, in the form of a general purpose or special purpose microprocessor, or of one or more digital signal processors. Memory 103 may comprise all forms of memory, such as random access memory (RAM), read-only memory (ROM), non-volatile memory such as EPROM or EEPROM, flash memory or a hard drive. Some of these types of memory may be removable from the communication device 100, e.g. flash memory cards, while others may be integrated for example with microprocessor 101. Memory 103 stores identification information identifying the subscriber using device 100.

The communication device 100 comprises a transceiver 104. The transceiver 104 comprises a transmitting unit 105 and a receiving unit 106 for communication over a communication network. The transmitting unit and the receiving unit may be integrated within one or more integrated circuits. In the embodiment of FIG. 1, transceiver 104 is a fully functional transceiver of a digital telephone and can be used to establish a phone connection over a digital telephone network to other communication devices. In other embodiments, transceiver 104 may be implemented as a fully functional cellular radio transceiver, a network interface, such as an Ethernet interface, a wireless network transceiver, or a radio transceiver. Depending on the implementation, transceiver 104 may work according to any suitable known standard. For example, when implemented as a cellular radio transceiver, the transceiver may work according to the global system for mobile communications (GSM), TIA/EIA-136, CDMA One, CDMA 2000, UMTS, or wideband-CDMA standard. Further standards, according to which transceiver 104 may work, comprise ISDN, ATM, GPRS, IEEE802.L, PPP, PPPOE, Ethernet, EDGE, and the like. Transceiver 104 may accordingly comprise different circuits for fixed-line or mobile communication and for data exchange, and may interface a landline and/or one or more antennas. In the embodiment of FIG. 1, transceiver 104 interfaces landline 107, by means of which it is connected to a digital telephone network, or a wide area network, e.g. via a router and a hub. Transceiver 104 is configured for transmitting and receiving data packets comprising voice data and identification information.

Communication device 100 further comprises a user interface 108. The user interface 108 comprises a keypad 109 by which a user may enter information and operate the communication device 100. Keypad 109 comprises alphanumeric keys, as well as control elements such as turn/push buttons, rockers, joystick-like control elements and similar. Keypad 109 may for example be used to enter a telephone number or user ID for establishing a connection via transceiver 104. Display 110 interfaces input/output unit 102 and is used to provide information to a user of communication device 100. Displayed information may comprise a function menu, service information, contact information characters entered by keypad 109 and it may in particular display information received by transceiver 104 such as identification information received with a data packet. In some embodiments, display 110 is implemented as a simple single line LCD display, yet in other embodiments, display 110 may be a full size LCD screen.

User interface 108 further comprises microphone 111 and loudspeaker 112. For voice communication over a communication network, such as an integrated services digital network (ISDN), or a GSM network, microphone 111 records the voice of a user of communication device 100, whereas loudspeaker 112 is an output unit reproducing a received voice signal. Audio processing unit 113 converts a received digital voice signal to an analog voice signal and interfaces loudspeaker 112 for giving the voice signal out. Audio processing unit 113 further interfaces microphone 111 for digitizing a recorded analog voice signal and for providing the digitized voice signal via input/output unit 102 to microprocessor 101 for further processing.

Communication device 100 may be implemented as a telephone to be connected to a digital telephone network. Yet it may also be implemented as a cellular telephone, a stand-alone IP phone, a soft phone, or a digital two-way radio. Communication device 100 may also comprise further components such as a video camera for enabling video telephony. Communication device 100 may connect to a plurality of communication networks, such as a telephone network, an integrated services digital network, a GSM or UMTS network, a local area network (LAN), a wireless local area network (WLAN), or the internet. Further implementations of device 100 comprise a personal data assistant, a wireless hand-held device or a walkie-talkie.

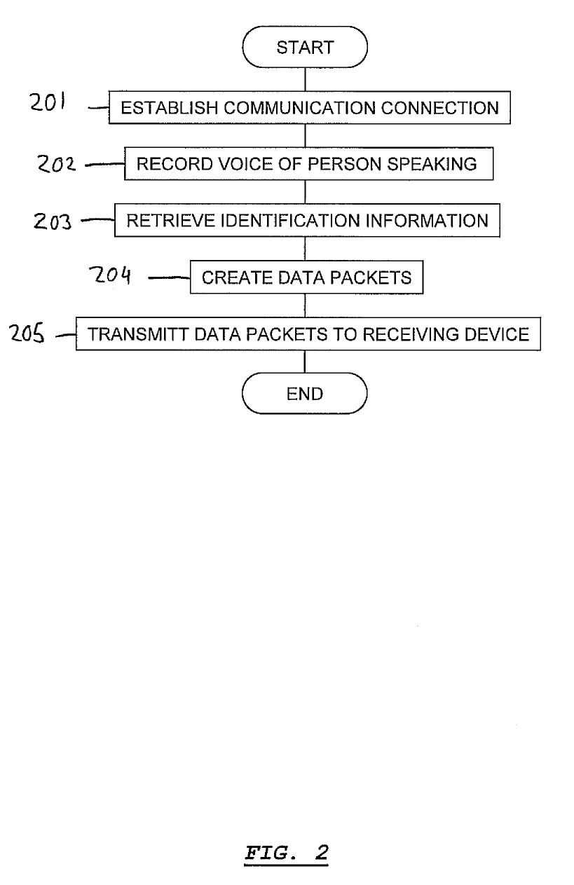

FIG. 2 shows an embodiment of a method according to the invention, which may be performed on the communication device 100. As an example, the communication device 100 is implemented as a stand-alone IP phone and connected to the internet over landline 107. In a first step 201, a communication connection is established. The user may for example enter a telephone number or a user identification by means of keypad 109. The connection is established by using a signaling protocol, such as the session initiation protocol (SIP). Once a connection to the receiving device is established, the subscriber of the communication device 100 can start to communicate with the user of the receiving device, wherein media streams are exchanged between the communication device and the receiving device. The connection used for communication may be a packet switched network connection, and may use the user datagram protocol (UDP) for the transport of data packets. The data packets may for example be real-time transport protocol (RTP) data packets, and may be transmitted as datagrams using UDP.

After the communication connection is established, the voice of the user of the communication device 100 is recorded by microphone 111 in step 202. The recorded voice is digitized using audio processing unit 113 and temporarily stored in memory 103. In step 203, identification information of the subscriber using the communication device 100 is retrieved. The identification information may be the name of the subscriber, an identification number of the subscriber, such as the telephone number or CLI, or MSISDN number, yet it may also comprise other information, such as an e-mail address or a voice over internet protocol (VoIP) user identification. The identification information is stored in memory 103, for example in a non-volatile memory, and is accessed by microprocessor 101.

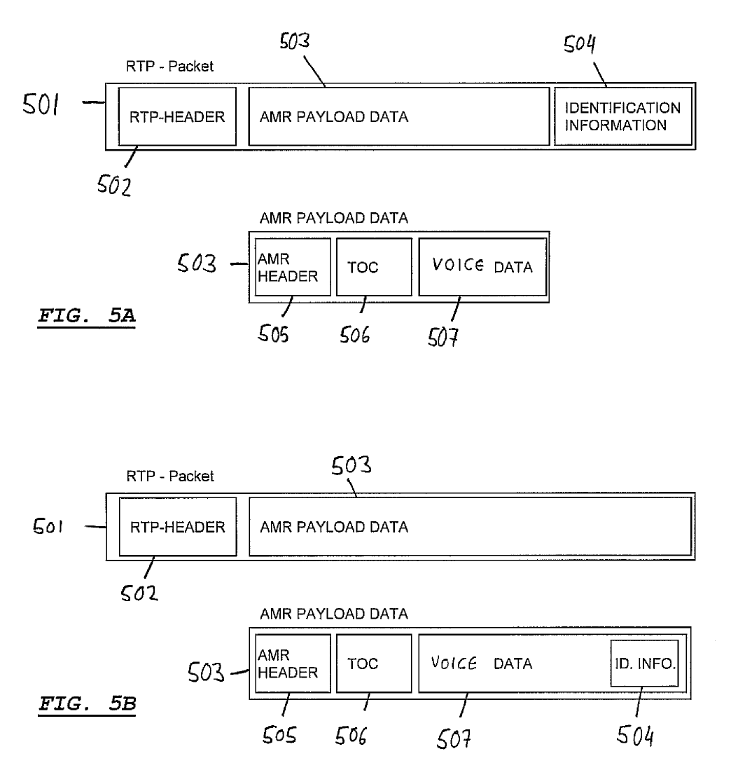

In step 204, data packets are created. For creating the data packets, processor 101 accesses the digitized voice signal stored temporarily in memory 103. Microprocessor 101 encodes the voice signal using an audicodec, such as adaptive multirate (AMR) or adaptive multirate wideband (AMR-WB). The voice signal may for example be sampled at 8000 Hz, and may be encoded into 20 ms speech frames each comprising 160 samples. As said before, other codecs may be used, e.g. PCM, A-law/mu-law, iLBC, MP3, AAC, compressed PCM and the like, which may use different frame sizes and sampling rates. One or more AMR speech frames may then be included into an RTP packet. Furthermore, the retrieved identification information is included into the RTP packet. Possible implementations for generating an RTP packet as described are shown in FIG. 5. FIG. 5A shows the situation where the RTP packet 501 comprises an RTP header 502, AMR payload data 503 and a section 504 comprising the identification information. The identification information 504 may have a length between 8 and 64 bytes, preferably between 16 and 32 bytes. The identification information may be stored in ASCII format with 1 byte per character. 32 bytes generally provide enough space for storing even longer names. The AMR payload data 503 comprises an AMR header 505, a table of contents 506 and the voice data 507. Voice data 507 may comprise a single AMR frame, yet it may also comprise plural AMR frames, which are designated in the table of contents 506. Note that the schematic drawings of FIG. 5 are not to scale, and that the voice data 507 generally takes up a significantly larger amount than the AMR header 505 and the table of contents 506.

Another implementation is shown in FIG. 5B, where the RTP packet 501 again comprises an RTP header 502 and AMR payload data 503. In this case, the identification information 504 is not attached to the end of the RTP packet 501 as in FIG. 5A, but it is included within the voice data 507. The voice data 507 may comprise several voice frames, and the identification information 504 may be included in only one of these voice frames. Voice data 507 may also comprise only one voice frame with the identification information. It should be clear that using RTP packets and AMR encoded voice is just one possibility, and that the method may be implemented using different data packets and different audiocodecs for encoding the voice. Other codecs comprise for example the full-rate codec, half-rate codec or enhanced full-rate codec, or simple pulse code modulation (PCM). The data packet may as such be just a simple data frame, which comprises the voice data and the identification information. Such frames may for example be used by ISDN network protocols, and frames in the form of fixed-size cells are used by the ATM protocol.

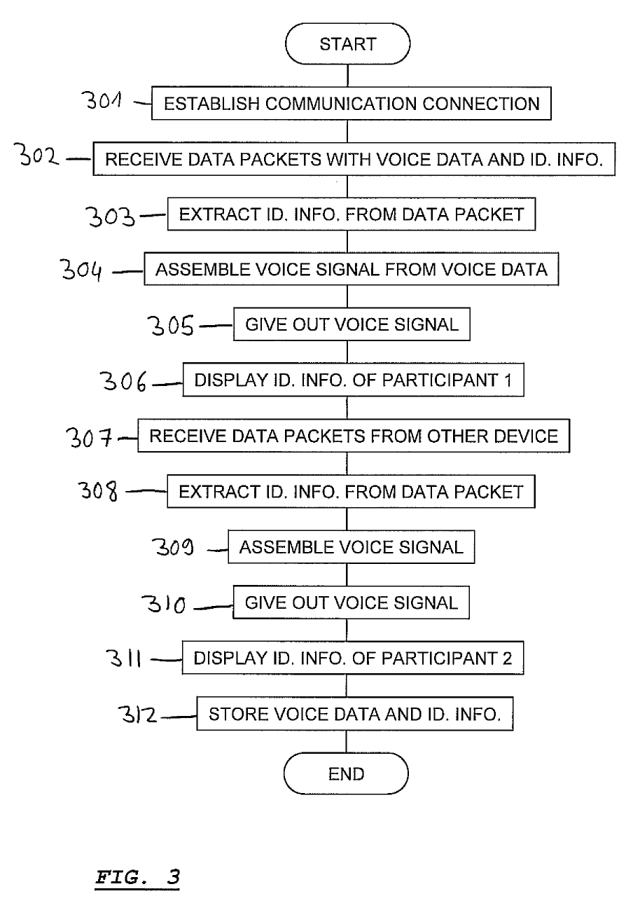

Referring back to FIG. 2, after the data packet was created in step 204, it is transmitted to a receiving device in step 205. The data packet is supplied to the transceiver 104 via input/output unit 102, and transceiver 104 transmits the data packets over the communication network to the receiver. In a packet switch communication network, the data packets may furthermore comprise an IP address header for being related to the correct recipient, yet in a circuit switched communication network, such an additional header may not required. While the user of the device 100 is speaking into the microphone, device 100 will generally continuously stream data packets through the communication network in the form of a media stream. All of the data packets created from the recorded voice may comprise the identification information, or only some data packets, depending on the application. By receiving the data packets, the receiving device is generally enabled to reproduce the voice signal and to access the identification information transmitted in the data packets. This situation will be explained in more detail with reference to FIG. 3.

FIG. 3 shows a flow diagram of another embodiment of a method according to the invention. The method is carried out at the above-mentioned receiving device, which may again be implemented at a stand-alone IP phone, with components similar to the communication device 100 of FIG. 1. In a first step 301, the receiving device establishes a communication connection with two further communication devices for conducting a telephone conference. All of the devices may use the method of FIG. 2 for transmitting recorded voice. The connection may again be established by using a signaling protocol such as SIP. In step 302, the receiving device receives data packets with voice data and identification information from a first communication device. The data packets are received by the receiving unit 106 of a transceiver 104, and are processed by microprocessor 101. Processing comprises extracting the identification information from the data packet in step 303, as well as extracting the one or more voice frames. Information on how many voice frames are comprised in the data packets and where they start, as well as on the location of the identification information may be comprised in the header, yet it may also be predetermined by using a standard. In both cases, the voice data and the identification information can be retrieved and temporarily stored in memory 103. Voice data is extracted from a plurality of data packets received with the media stream from the first communication device, and a voice signal is assembled from the received voice data in step 304. Receiving and extracting the voice data, assembling the voice signal and giving it out are performed continuously while data packets are received, wherein the delay is kept to a minimum. The assembled voice signal is given out in step 305, e.g. by loudspeaker 112, while the identification information identifying the first participant, i.e. the subscriber of the first communication device, is displayed on display 110 (step 306). Accordingly, the name of the first participant is displayed to the user of the receiving device in case the name is comprised in the identification information. The name may be displayed as soon as the first data packets comprising identification information are received, and may then be displayed while the connection is still established, yet it may also be displayed only while the first participant is speaking, or may be highlighted while the first participant is speaking. Accordingly, it is always possible for the user of the receiving device to identify the person currently speaking. This is even possible if no further information was previously exchanged, e.g. during the session initiation, or by means of a session control protocol. Also, it is possible to display the identity of the other participant without requiring any extensive data processing, such as speech recognition.

In a next step 307, data packets are received from a second communication device. As in step 303, the identification information and voice data comprised in the data packets are extracted (step 308). The voice signal is assembled in step 309. The voice signal is given out in step 310, while the identification information of the second participant is displayed in step 311. As an example, the display of the receiving device may display both the names of the first and the second participants, and may highlight the name of the participant currently speaking. Even without being able to distinguish their voices, the user of the receiving device is now enabled to identify the speaking person. Furthermore, she/he is directly provided with the names of the other participants. This is particularly useful for telephone conferences, in which the participants do not already know each other. Furthermore, it is possible to transmit further identification information, such as an e-mail address or identification numbers. The identification information may be provided in a form in which it can be directly used, e.g. implemented in an address book or the like.

In a further step 312, the voice data and the identification information are stored. As the identification information is received together with the voice data, the voice data can be stored in association with the correct identification information, i.e. the name of the participant, and accordingly, a conversation log can be generated. It is thus possible to directly identify the originator of the particular contribution. The voice data and the identification information may for example be stored in a non-volatile memory comprised in memory 103.

It should be clear that not all steps in FIG. 3 need to be carried out, e.g. the method may also be performed in a connection between two subscribers only, and storing of the voice data and the identification information is optional.

Some situations may arise where the device transmitting the data packets is operating according to the method of FIG. 2, wherein the data packets comprise identification information, yet the receiving device is not configured to interpret or make use of said identification information. In such situations, it is beneficial to not include the identification information in a critical part, such as the header of the data packet, or the header of the AMR payload. The identification information may simply be introduced in the AMR payload, i.e. the voice data 507, as shown in FIG. 5B. In that case, the receiving device not being capable of extracting the identification information, will not notice and simply ignore the information or discard the voice frame as corrupt and non-compliant. The identification information may thus not bypass the voice decoder. Accordingly, a communication device or terminal not supporting this feature will not be affected by adding the identification information to the media packet carrying the individual voice frame. The identification information may also be placed in one of the headers of the data packet in such a way that a receiving device not capable of extracting the information does not notice its presence, and accordingly, processes the data packet as usual.

As can be seen from the above description, the proposed method has several advantages over prior methods of exchanging voice data in a communication network. Even without any prior information exchanged, participants of a communication session implementing the above-described methods are enabled to identify the other participants. On the terminus of the participants, real-time updates of the person currently speaking can be provided. The methods are easy to implement, and do not require extensive processing of the speech signals, nor the exchange of additional control protocols.

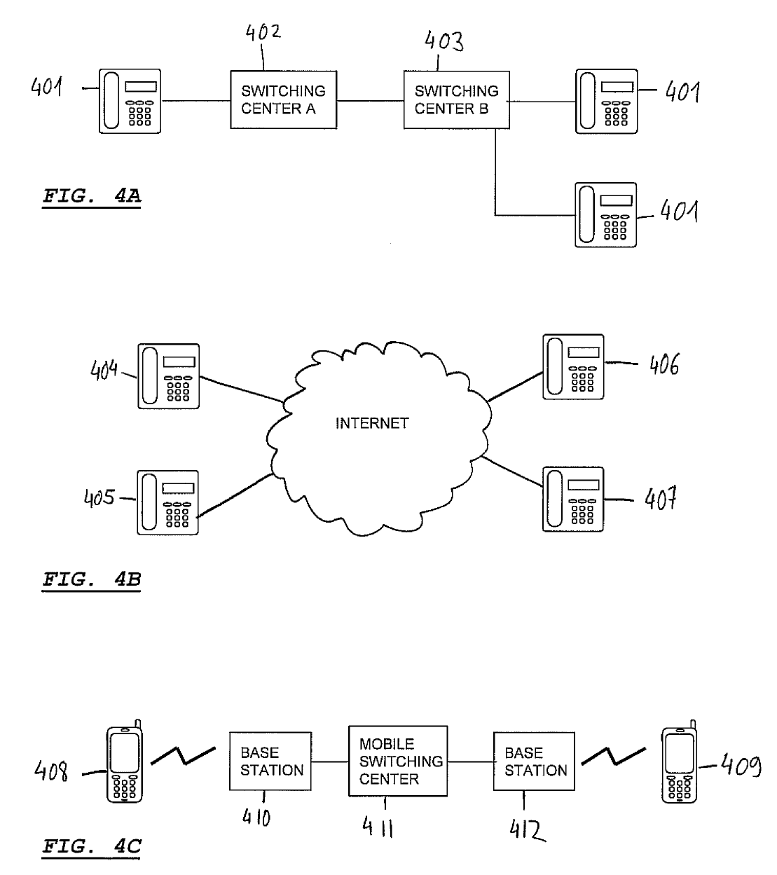

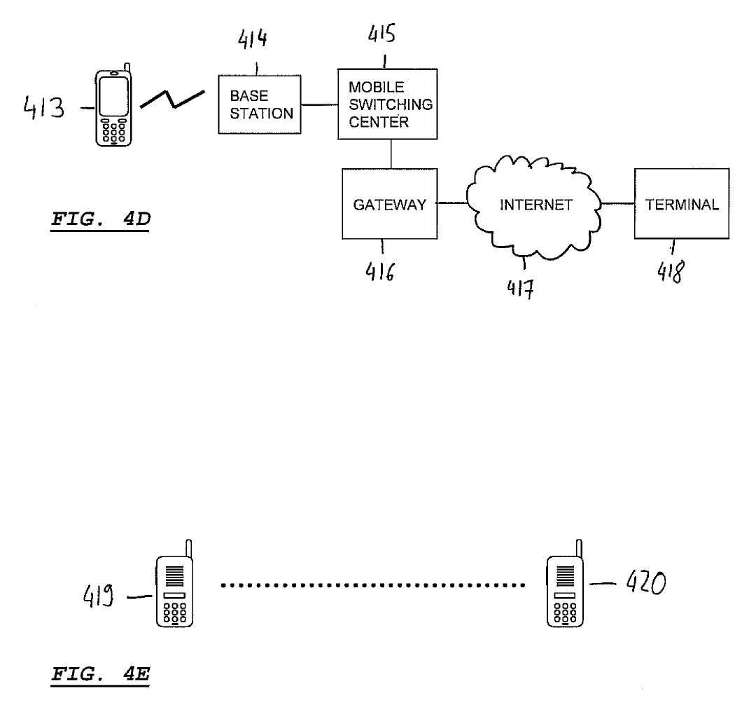

FIG. 4 shows several embodiment and applications of communication devices implementing a method according to an embodiment of the invention. It should be noted that these are only schematic drawings for illustration purposes and do not comprise all the components of the respective communication networks. FIG. 4A shows three digital telephones 401, with one telephone being connected to switching center A 402, and two of the digital telephones being connected to switching center B 403. Switching centers A and B may interface each other directly, or via other switching centers, e.g. regional, sectional or primary switching centers. The telephone network may be a ISDN network, and voice data may be exchanged by using a pulse code modulation (PCM) data stream, into which the identification information is incorporated. The three telephones shown in FIG. 4A may participate in a telephone conference, or two of the telephones may establish a connection with each other, over which the identification information is exchanged together with voice data.

FIG. 4B shows the situation where four participants communicate over the internet using voice over IP telephony. The communication devices 404 and 405 may for example be implemented as stand-alone IP telephones, whereas communication device 406 may be implemented as a wireless IP telephone, and communication device 407 as a soft phone. A soft phone is a computer terminal connected to the internet and running software for emulating a phone, with a headset comprising the microphone and the loudspeaker being connected to the computer terminal as part of a user interface. For communication, the phones 404 to 407 may send and receive media streams. In this application, the voice data is preferably transported by means of the real-time transport protocol, which is controlled by the real-time control protocol (RTCP). For the transportation of the RTP data packets, the user datagram protocol is used. By using UDP, the delay between the recording of a voice signal and the reproduction of the voice signal is minimized. By means of a gateway, connection to a digital telephone network may furthermore be established, and accordingly to one of the digital telephones shown in FIG. 4A. As the identification information of each participant is again transmitted in association with the voice data over the communication network, each of the VoIP phones 404 to 407 is capable of displaying the identification information of the participants and of informing its user of the participant currently speaking.

FIG. 4C shows the application to mobile communication. Communication devices are implemented as cellular phones 408 and 409. Cellular phones 408 and 409 establish a connection via base station 410, mobile switching center 411 and base station 412. For illustration purposes, control centers and other components of the mobile telephony network are not shown. Mobile phones 408 and 409 may communicate with base stations 410 and 412 by using a GSM or UMTS mobile telephony network. Voice data may be transmitted over such a network in an AMR encoded format. The connection may be established using any of the known channel access methods, such as frequency division duplex (FDD). Over the connection, AMR frames comprising identification information are exchanged between the cellular phones 408 and 409, again enabling the cellular phone to provide the identification information on the other subscriber to the respective user. The mobile switching center 411 may of course be connected to a switching center of a digital telephony network, so that a connection to a digital telephone, e.g. one of the telephones 401, may be established.

Furthermore, the method of the invention may be applied to a push to talk over cellular application, which can be implemented on cellular phone networks such as GSM, GPRS, EDGE, CDMA or UMTS. A push-to-talk application may again use an RTP protocol and AMR encoding for the transmission of voice frames. The connection may again be set up using the SIP protocol, the connection being packet switched. By using push to talk, an active talk group can be reached by the push of a button. As a plurality of participants may communicate within a push-to-talk session, it is advantageous to implement the method of the present invention, as the person receiving the push-to-talk message can immediately identify the person currently speaking.

FIG. 4D shows a further implementation. Cellular phone 413 builds up a connection to base station 414 via a GSM network, the connection to terminal 418 is established via the mobile switching center 415, the gateway 416, and an internet network connection 417. In this scenario, the speech is transmitted from a non-IP system, here a GSM network, to a voice over IP terminal 418. The packaging of an AMR voice frame may be different in the non-IP network and may have to be repacketized into an RTP packet at gateway 416. Repacketizing is preferably performed in such a way that the identification information comprised in an AMR frame or an RTP packet is preserved. Accordingly, even though the voice data and the identification information are transmitted from terminal 418 to gateway 416 using UDP/RTP transmission, and further transmitted from gateway 416 to cellular phone 413 using AMR over GSM transmission, the identification information can be provided to the user of cellular phone 413 while the associated speech data is given out. It should be clear that the mobile switching center 415 or gateway 416 may further interface the switching center of the digital telephone network. Accordingly, a telephone conference may be set up comprising plural cellular phones, VoIP terminals and digital telephones.

In the embodiment of FIG. 4E, the communication devices are implemented as two-way radios 419 and 420. Such two-way radios may communicate on a common, selectable channel. If receiving devices are tuned to the same channel as a transmitting device and within the reception range of the transmitting device, they can receive a radio signal transmitted by the transmitting device. For participants communicating together over such a radio channel, it is desirable to know the identities of the other participants. This is particularly the case when the participants do not yet know each other, which is often the case when communicating on a public channel. When implementing one of the above-described methods on the devices 419 and 420, the radio signal exchanged between the devices comprises data packets with voice data and identification information. When device 420 receives such a data packet from device 419, it is enabled to display the identity of the user of device 419. The user of device 420 is thus always informed about the identity of the participant whose voice is being reproduced. Device 420 may also display a list of the identities of all participants that are participating in the communication.

Devices 419 and 420 may also be implemented as cellular phones establishing a direct connection. Cellular phones may be equipped with a direct talk feature and may be able to provide a “walkie-talkie” service. When using such a walkie-talkie service, media streams are again exchanged on a common broadcast channel. The media streams carry packets or frames comprising voice data and identification information. The device receiving such a data packet or data frame is again enabled to display the identification information to its user. In such an ad-hoc voice session, it is therefore also possible to provide a participant with the identity information of the other participants. In particular, it is possible for a participant to see who is currently broadcasting, i.e. speaking, over the common broadcast channel.

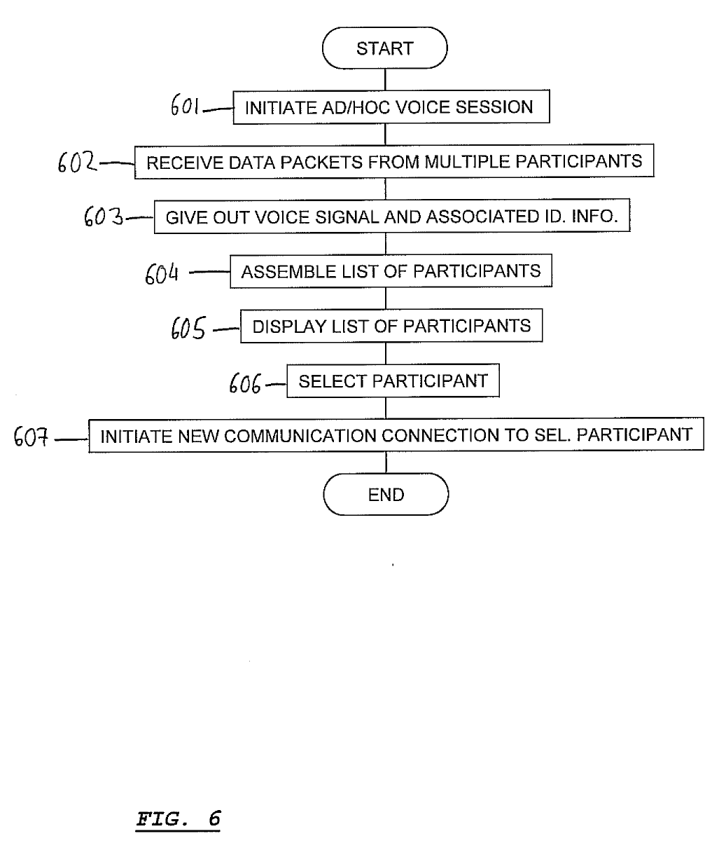

A further embodiment of a method according to the invention is schematically illustrate in FIG. 6. In a first step 601 of the flow diagram, an ad-hoc voice session is initiated. It may be initiated by using e.g. a two-way digital radio, or a cellular phone with a direct-talk feature. In step 602, data packets are received from multiple participants of the voice session. The participants may subsequently be transmitting over a common broadcast channel, and these media streams from the participants are received and each comprise data packets with voice data and associated identification information. In step 603, the voice signal and the associated identification information are given out to the user of the communication device. Accordingly, the user can always identify the person presently speaking. In the next step 604, the communication device assembles a list of the participants of the voice session. The list is displayed to the user in step 605. In step 606, the user may select a particular participant from said list to whom he wants to talk privately to. In step 607, the communication device initiates a new communication session with the selected participant. The communication may be initiated on a separate channel, or through other means, e.g. by establishing a cellular phone connection to the selected participant, or by any other media, like Videocall, messaging, GSM and the like. The user of the communication device is thus not only provided with the identification information of the participant, but also with contact information, which enables him to directly contact the participant. This is particularly useful when communicating with a previously unknown person over a common broadcast channel, as the user may not have the contact details available for that person. Such contact details can be transmitted as part of the identification information comprised in the data packets. Contact details may further comprise a Vcard, a URL, a URI and the like.

While specific embodiments of the invention are disclosed herein, various changes and modifications can be made without departing from the spirit and the scope of the invention. The present embodiments are to be considered in all respects as illustrative and non-restrictive, and all changes coming within the meaning and equivalency range of the appended claims are intended to be embraced therein.

1-32. (canceled)

33. In a communication network, a method comprising:
retrieving identification information that identifies a subscriber associated with a transmitting device;
creating a data packet that includes the identification information and voice data from the transmitting device; and
transmitting, by the transmitting device, the data packet to a receiving device, wherein the data packet is configured to enable the receiving device to present the identification information to a user of the receiving device.

34. The method of claim 33, wherein the identification information comprises at least one identification detail, wherein the at least one identification detail comprises a name, an email address, a cellular phone number, a fixed line phone number, a mobile subscriber integrated services digital network number (MSISDN), a caller line identification (CLI), or a voice over internet protocol (VoIP) user identification.

35. The method of claim 33, wherein the identification information comprises an identification frame attached to an end of the data packet or is contained in a data section of a voice frame that includes the voice data.

36. The method of claim 33, wherein the identification information comprises 8 to 64 bytes.

37. The method of claim 33, wherein the data packet is a real-time transport protocol (RTP) data packet.

38. The method of claim 33, wherein the voice data comprises at least one voice frame encoded using an adaptive multi-rate (AMR) or adaptive multi-rate wideband (AMR-WB) format.

39. The method of claim 33, wherein a plurality of data packets are transmitted by the transmitting device, wherein each of the data packets includes the identification information.

40. The method of claim 33, wherein the data packet is included in a media stream transmitted over a communication connection between at least the transmitting device and the receiving device, the communication connection comprising at least one of a telephone connection, a telephone conference, a video conference, an ad-hoc voice session, voice over internet protocol (VoIP) telephony, or a two-way radio connection.

41. The method of claim 33, further comprising:
receiving the data packet at the receiving device;
accessing the identification information from the data packet; and
presenting the identification information to the user of the receiving device.

42. A method of receiving voice data via a communication network, comprising:
receiving, at a receiving device, a data packet that includes voice data and identification information;
accessing the identification information from the data packet; and
presenting the accessed identification information to a user of the receiving device, wherein the identification information identifies a subscriber associated with the transmitting device.

43. The method of claim 42, wherein the presenting the accessed identification information comprises:
rendering the identification information to the user while a voice signal is assembled using the voice data presented to the user in audible form or while text transcribed from the voice data is presented to the user.

44. The method of claim 42, further comprising:
receiving a plurality of data packets comprising other voice data and the identification information in a media stream exchanged between the transmitting device and the receiving device;
assembling the received voice data and the other voice data to a plurality of voice signals; and
rendering the voice signals via a loudspeaker.

45. The method of claim 42, further comprising:
storing the voice data and the identification information at the receiving device.

46. The method of claim 42, wherein data packets that include other voice data and other identification information are received from a plurality of transmitting devices, and wherein the other identification information is presented to the user while rendering the other voice data to the user.

47. The method of claim 42, wherein the data packet is directly received from the transmitting device transmitting the data packet during an ad-hoc voice session.

48. The method of claim 47, wherein the receiving the identification information enables the receiving device to initiate establishment of a new connection with the transmitting device.

49. The method of claim 42, further comprising:
retrieving other identification information that identifies another subscriber of the receiving device;
creating another data packet that includes other voice data and the other identification information; and
transmitting the other data packet to another receiving device, wherein the other data packet is configured to enable the other receiving device to provide the other identification information to another user of the other receiving device.

50. A device to transmit voice data in a communication network, comprising:
a memory to store identification information that identifies a subscriber associated with the device;
a processing unit to create a data packet that includes voice data and identification information; and
a transmitting unit to transmit the data packet to a receiving device, wherein the data packet is configured to enable the receiving device to present the identification information to a user of the receiving device.

51. The device of claim 50, further comprising:
a microphone for recording a voice signal, wherein the processing unit generates the voice data from at least a portion of the voice signal.

52. The device of claim 50, wherein the processing unit is configured to create the data packet in a real-time transport protocol format, the data packet including at least one adaptive multi-rate (AMR) or adaptive multi-rate wideband (AMR-WB) encoded voice frame.

53. The device of claim 50, wherein the device comprises at least one of a cellular phone, a fixed line phone, an internet protocol (IP) telephone, a soft phone, a teleconference system, a video teleconference (VTC) system, a video telephone, or a telecommunications system.

54. The device of claim 50, further comprising:
a receiving unit to receive another data packet that includes other voice data and other identification information that identifies another subscriber associated with a transmitting device that transmits the other data packet, wherein the processing unit is further configured to access the other identification information from the received data packet; and
an output unit to present the other identification information to a user of the device.

55. A device to receive voice data in a communication network, comprising:
a receiving unit to receive a data packet, the data packet including voice data and identification information that identifies a subscriber associated with a transmitting device that transmits the data packet;
a processing unit to access the identification information from the received data packet; and
an output unit to present the identification information to a user of the device.

56. The device of claim 55, wherein the processing unit is further configured to compose a voice signal from the voice data, the device further comprising:
a voice output unit to render the voice signal while the identification information is presented to the user.

57. The device of claim 55, wherein the receiving unit is configured to receive a plurality of data packets from a plurality of transmitting devices, and wherein other identification information included in a first one of the data packets from one of the transmitting devices that identifies another subscriber associated with the one transmitting device is presented to the user while other voice data included in the first data packet from the one transmitting device is presented to the user.

58. The device of claim 55, further comprising:
a memory to storing the voice data and the identification information.

59. The device of claim 55, wherein the device comprises at least one of a cellular phone, a fixed line phone, an internet protocol (IP) telephone, a soft phone, a teleconference system, a video teleconference (VTC) system, a video telephone, or a telecommunications system.

60. The device of claim 55, further comprising:
a memory to store other identification information that identifies a subscriber associated with the device, wherein the processing unit is further configured to create another data packet that includes the identification information and other voice data;
a transmitting unit to transmit the other data packet to a receiving device.

61. A communication device comprising:
means for storing first identification information that identifies a first subscriber associated with the communication device;
means for creating a data packet comprising the first identification information and first voice data from a first user of the communication device;
means for transmitting the data packet to a receiving device;
means for receiving a data packet comprising second identification information identifying a second subscriber associated with the transmitting device and voice data from a second user of the transmitting device;
means for accessing the second identification information; and
means for presenting the second identification information to the first user.

62. The communication device of claim 61, further comprising:
means for establishing a connection with at least one other communication device, wherein over the connection, a plurality of data packets are sent and received as media streams by the communication device, wherein at least one of the data packets comprises the identification information, and wherein at least one of the received data packets comprises identification information of the other communication device.

63. A processor-readable medium having processor-executable instructions for transmitting voice data in a communication network stored thereon, which when executed on a processor of a transmitting device, perform a method comprising:
retrieving identification information identifying a subscriber associated with the transmitting device;
creating a data packet comprising the identification information and voice data from the transmitting device; and
initiating transmission of the data packet to a receiving device, the data packet being configured to enable the receiving device to present the identification information to a user of the receiving device.

64. A processor-readable product having processor-executable instructions for receiving voice data in a communication network, which when executed on a processor of a receiving device, perform a method comprising:
accessing identification information included in a data packet received from a transmitting device, wherein the data packet comprises the identification information and voice data from the transmitting device; and
presenting the identification information to a user of the receiving device, the identification information identifying a subscriber associated with the transmitting device.
